(19) United States
(12) Patent Application Publication
(10) Pub. No.: US 2008/0090482 A1
(43) Pub. Date: Apr. 17, 2008

(54) Method of manufacturing plasma display panel

(76) Inventor: Tae-Kyoung Kang, Suwon-si (KR)

Correspondence Address: ROBERT E. BUSHNELL, 1522 K STREET NW, SUITE 300, WASHINGTON, DC, 20005-1202, US

(21) Appl. No.: 11/907,520

(22) Filed: Oct. 12, 2007

(30) Foreign Application Priority Data
Oct. 12, 2006 (KR) 1020060099364

(51) Int. Cl. H01J 9/02

(52) U.S. Cl. 445/24

(57) ABSTRACT

Provided is a method of manufacturing a plasma display panel. The method includes preparing a substrate having a display area for displaying an image and a non-display area formed on edges of the display area, forming a plurality of discharge electrodes extending from the display area to the non-display area, and barrier ribs defining discharge cells, and continuously and simultaneously applying raw materials for forming phosphor layers for emitting lights of various colors in the discharge cells using a plurality of dispensers that move from one direction to another direction on the substrate. The raw materials for forming the phosphor layer for emitting lights various colors can be simultaneously and continuously applied using the dispenser, and thus the process of applying the raw materials for forming the phosphor layers is simplified. Also, the locations of the dispensers in the non-display area are different, and thus the thickness difference due to the overlapping raw materials can be reduced.

### CLAIM OF PRIORITY

This application makes reference to, incorporates the same herein, and claims all benefits accruing under 35 U.S.C. §119 from an application for METHOD OF MANUFACTURING PLASMA DISPLAY PANEL earlier filed in the Korean Intellectual Property Office on 12 Oct. 2006 and there duly assigned Serial No. 10-2006-0099364.

### BACKGROUND OF THE INVENTION

1. Field of the Invention

The present invention relates to a method of manufacturing a plasma display panel, and more particularly, to a method of manufacturing a plasma display panel which includes a new mechanism for coating raw materials for forming phosphor layers in discharge cells defined by barrier ribs.

2. Description of the Related Art

Conventionally, a plasma display panel is a flat display device that displays desired numbers, letters, or images using light emitted from an excited phosphor material of a phosphor layer formed in a discharge cell filled with a discharge gas. The phosphor layer is excited by ultraviolet rays generated by applying a predetermined voltage between discharge electrodes respectively formed on a plurality of substrates facing each other.

A conventional method of manufacturing a plasma display panel includes manufacturing a front substrate, manufacturing a rear substrate, and assembling the front substrate and the rear substrate.

Conventionally, a phosphor layer emitting ultraviolet rays is formed by applying a raw material for a phosphor layer on a layer via a screen printing method. However, it is not easy to form the phosphor layer using the screen printing method, since an opening of a screen is blocked after repeatedly printing the raw material on a plurality of layers. Accordingly, the screen needs to be changed periodically. Also, red, blue, and green phosphor layers cannot be printed at the same time, but have to be printed separately. Thus, a method of forming phosphor layers is complicated and time consuming.

In order to address these problems, a method of spraying a raw material for forming a phosphor layer on barrier ribs using a dispenser has been developed. As shown in FIG. 1, a substrate 100 is divided into a display area 101 for displaying an image and a non-display area 102 surrounding the outer boundary of the display area 101.

In order to uniformly spray the raw material for forming the phosphor layer on the display area 101, a discharge rate of the raw material is uniformly increased to a predetermined value starting from the non-display area 102. Then, the raw material for phosphor layer is uniformly sprayed on the display area 101. According to the method, the raw material can be sprayed as follows.

To spray the raw material, the dispenser is placed above the bottom left area of the substrate 100, and moves from the bottom to the top while applying the raw material in a discharge cell (along a solid arrow line). Next, the dispenser stops discharging the raw material and moves diagonally (along marked by a dotted line). Then, the process of applying the raw material is repeated.

However, the this method of applying the raw material for forming the phosphor layer is time consuming, because the dispenser stops discharging the raw material while moving along the dotted lines, and then start discharging the raw material again when it moves along the solid lines. An applying path of the raw material is defined as a path along which the dispenser moves while applying the raw material for the phosphor layer to the substrate. A moving path of the dispenser is defined as a path along which the dispenser moves while applying or not applying the raw material. Therefore, in FIG. 1, the moving path is the total trace that is represented by both of the solid and dotted lines, while the applying path is the trace that is only represented by the solid lines. In this case, the moving path and the applying path are not identical (or different), because the raw material is not applied while the dispenser is moving along the dotted lines. Because the moving path and the applying path is not the same, the phosphor layer is formed by repeating the processes of applying the raw material and stopping the discharge of the raw material while moving the dispenser. Therefore this process is not efficient and time consuming.

### SUMMARY OF THE INVENTION

The present invention provides a method of manufacturing a plasma display panel including a simplified process of continuously applying raw materials for phosphor layers in discharge cells defined by barrier ribs by using a dispenser.

According to an aspect of the present invention, there is provided a method of manufacturing a plasma display panel, the method including preparing a substrate having a display area for displaying an image and a non-display area surrounding the edges of the display area, forming a plurality of discharge electrodes extending from the display area to the non-display area, and barrier ribs defining discharge cells, and continuously and simultaneously applying raw materials for forming phosphor layers for emitting lights of various colors in the discharge cells using a plurality of dispensers that move from one direction to another direction the substrate.

The barrier ribs may be formed in a predetermined pattern including main barrier ribs, which are formed on the display area, and dummy barrier ribs, which extend from the main barrier ribs and are formed on the non-display area.

In the applying of the raw materials for forming the phosphor layers, the raw materials for forming phosphor layers emitting lights of a first through an n colors may be simultaneously applied in the discharge cells along one direction of the substrate, so that the raw materials are applied via single process.

The moving direction of the dispensers and the applying direction of the raw materials for forming the phosphor layers may be the same.

In the simultaneously applying of the raw material for phosphor layer, processes of applying the raw material for phosphor layer as the dispenser moves from a first area to a second area, which is on the opposite direction of the first area, of the substrate, horizontally moving the dispenser to the adjacent discharge cell, and applying the raw material for phosphor layer as the dispenser moves from the second area to the first area of the substrate may be repeated.

The method may further include forming dielectric layers covering the discharge electrodes on the substrate, wherein the dielectric layers cover the discharge electrodes disposed on the display area, excluding the non-display area.

An interval between the discharge electrode portions disposed corresponding to the non-display area where the raw materials for forming the phosphor layers are formed may be larger than an interval between the discharge electrode portions disposed on the display area.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a method of applying a raw material for forming a phosphor layer;

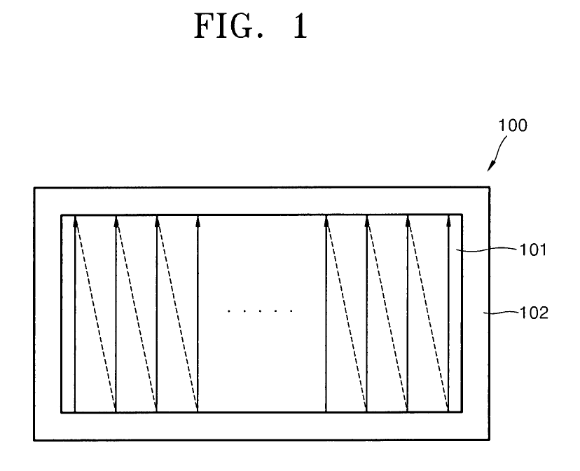

FIG. 2 is an exploded perspective view of a plasma display panel according to an embodiment of the present invention;

FIG. 3 is a perspective view illustrating a method of applying raw materials for phosphor layers in the discharge cells of the plasma display panel illustrated in FIG. 2;

FIG. 4 is a diagram for describing a process of applying raw materials for phosphor layers according to an embodiment of the present invention;

FIG. 5 is a diagram for describing a process of applying raw materials for phosphor layers according to another embodiment of the present invention;

FIG. 6 is a diagram for describing a process of applying raw materials for phosphor layers according to another embodiment of the present invention;

FIG. 7 is a diagram for describing a process of applying raw materials for phosphor layers according to another embodiment of the present invention; and

FIG. 8 is a diagram for describing a process of applying raw materials for a phosphor layer according to another embodiment of the present invention.

### DETAILED DESCRIPTION OF THE INVENTION

Hereinafter, the present invention will be described more fully with reference to the accompanying drawings, in which exemplary embodiments of the invention are shown.

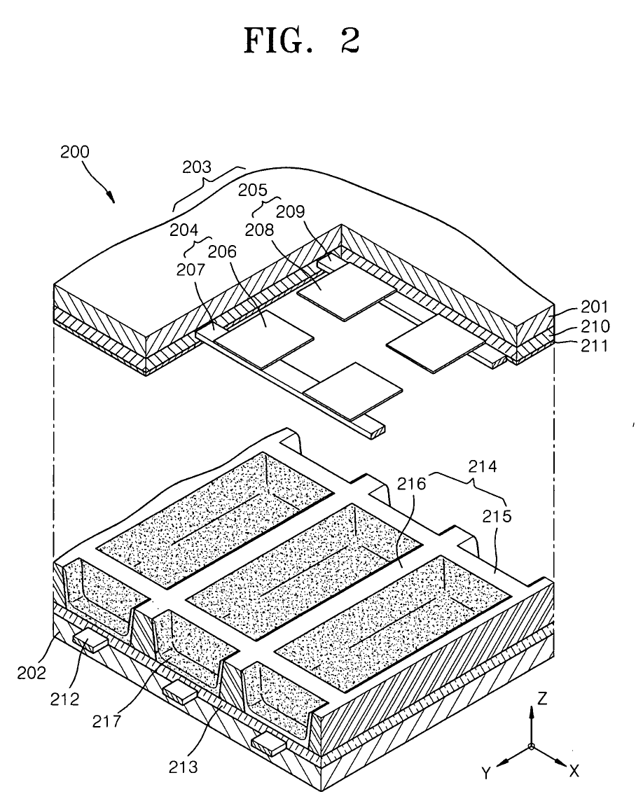

FIG. 2 is an exploded perspective view of a plasma display panel 200 according to an embodiment of the present invention. Referring to FIG. 2, the plasma display panel 200 includes a first substrate 201 and a second substrate 202 disposed parallel to the first substrate 201. Frit glass (not shown) is applied on the edges of surfaces of the first substrate 201 and the second substrate 202.

The first substrate 201 is formed of a transparent substrate, for example, soda lime glass. Alternatively, the first substrate 201 may be formed of a semitransparent substrate, a colored substrate, a reflecting substrate, etc. The second substrate 202 can substantially be formed of the same material as the first substrate 201.

Barrier ribs 214 are formed between the first substrate 201 and the second substrate 202 in order to define discharge cells with the first substrate 201 and the second substrate 202. The barrier ribs 214 includes first barrier ribs 215 disposed along an X direction of the plasma display panel 200 and second barrier ribs 216 disposed along an Y direction of the plasma display panel 200. After being assembled, the discharge cells defined by the first substrate 201, the second substrate 202, and the barrier ribs 214 form a lattice structure.

The barrier ribs 214 may be of various types, such as a meander type, a delta type, a waffle type, a honey type, etc. Also, the discharge cells defined by the barrier ribs 214 may have not only a tetragonal cross section as illustrated in the current embodiment, but also other cross sections, such as a polygonal cross section, a circular cross section, an oval cross section, etc.

A pair of sustain discharge electrodes 203 is disposed on an inner surface of the first substrate 201. The pair of sustain discharge electrodes 203 includes X electrodes 204 and Y electrodes 205 extending along the X direction. The X electrodes 204 and the Y electrodes 205 are alternatively disposed along the Y direction of the plasma display panel 200.

The X electrode 204 includes first transparent electrodes 206 formed on the inner surface of the first substrate 201 and a first bus electrode line 207 electrically connected to the first transparent electrodes 206. The Y electrode 205 and the X electrode 204 have substantially the same form. The Y electrode 205 includes second transparent electrodes 208 formed on the inner surface of the first substrate 201 and a second bus electrode line 209 electrically connected to the second transparent electrodes 208.

The first transparent electrodes 206 and the second transparent electrodes 208 are independently disposed in each of the discharge cells and may have tetragonal shapes, but are not limited thereto. Also, the first transparent electrodes 206 and the second transparent substrates 208 are spaced apart from each other at a predetermined interval in order to form discharge gaps therebetween.

The first bus electrode line 207 and the second bus electrode line 209 cross the discharge cells adjacent to each other along the X direction of the plasma display panel 200, and are each disposed on both edges of the discharge cells. The first bus electrode line 207 and the second bus electrode line 209 overlap on the edges of the first transparent electrode 206 and the second transparent electrode 208.

The first transparent electrode 206 and the second transparent electrode 208 are formed of a transparent conductive film, for example, an indium tin oxide film, in order to improve an aperture ratio of the first substrate 201. The first bus electrode line 207 and the second bus electrode line 209 are formed of a conductive metal in a multi-layer form, for example, a silver paste or a chrome-copper-chrome alloy, in order to improve the electric conductivity of the first and second transparent electrodes 206 and 208.

Also, a space between one sustain discharge electrodes 203 disposed above one of the discharge cells and another sustain discharge electrodes 203 disposed above an adjacent discharge cell can correspond to a non-discharge area. In the non-discharge area, a black stripe layer may be formed in order to improve contrast.

The sustain discharge electrodes 203 are covered by a first dielectric layer 210. The first dielectric layer 210 is formed of a high dielectric material, for example, ZnO—B₂O₃—Bi₂O₃. The first dielectric layer 210 can be selectively formed on portions where the sustain discharge electrodes 203 are formed, or can be formed on the entire surfaces of the first substrate 201.

A protective layer 211, such as magnesium oxide (MgO), is formed on the surface of the dielectric layer 210 in order to prevent damage of the first dielectric layer 210 and to improve emission of secondary electrons.

Address electrodes 212 are disposed on an inner surface of the second substrate 202. The address electrodes 212 cross the Y electrodes 205. The address electrodes 212 are covered by a second dielectric layer 213. The second dielectric layer 213 is formed of a high dielectric material, for example, PbO—B₂O₃—SiO₂.

Meanwhile, a discharge gas, such as neon-xenon or helium-xenon, is injected in the discharge cells defined by the first substrate 201, the second substrate 202, and the barrier ribs 214.

Phosphor layers 217 for emitting light, when excited by ultraviolet rays generated by the discharge gas, are respectively formed inside the discharge cells. The phosphor layer 217 can be formed on any area of the discharge cell, and in the current embodiment, the phosphor layer 217 is formed on the inner surface of the second substrate 202 and inner sidewall of the barrier ribs 214.

The phosphor layer 217 may be a red, green, or blue phosphor layer, but is not limited thereto. The red phosphor layer 217 may be formed of (Y,Gd)BO₃;Eu⁺³, the green phosphor layer 217 may be formed of Zn₂SiO₄:Mn²⁺, and the blue phosphor layer 217 may be formed of BaMgAl₁₀O₁₇:Eu²⁺.

The red, green, and blue phosphor layers 217 can be formed in the discharge cells by simultaneously applying raw materials for red, green, or blue phosphor layers, using an application means, such as a dispenser.

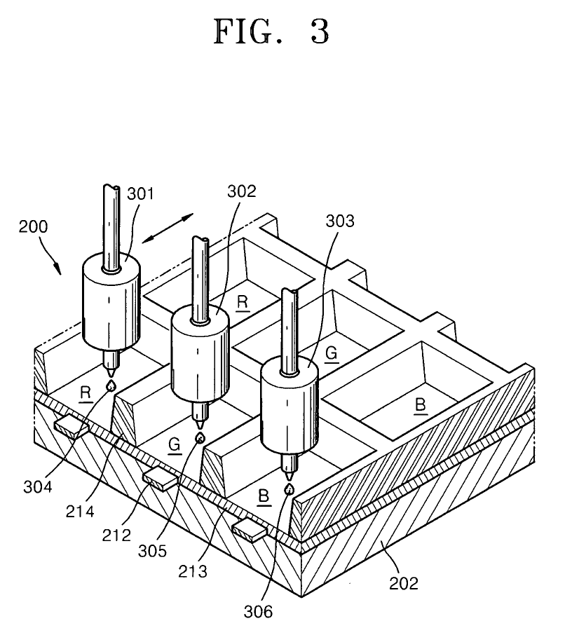

FIG. 3 is a perspective view illustrating a method of applying raw materials for phosphor layers in discharge cells of a plasma display panel 200. Referring to FIG. 3, in the plasma display panel 200, a red discharge cell R, a green discharge cell G, and a blue discharge cell B are defined by barrier ribs 214. A dispenser 301 discharging a raw material for a red phosphor layer 304, a dispenser 302 discharging a raw material for a green phosphor layer 305, and a dispenser 303 discharging a raw material for a blue phosphor layer 306 are arranged in a line above each of the discharge cells R, G, and B, respectively. The dispensers 301, 302, and 303 move continuously from one direction to another direction of a substrate 202 while applying the raw material for the red phosphor layer 304, the raw material for the green phosphor layer 305, and the raw material for the blue phosphor layer 306 in the discharge cells R, G, and B, respectively.

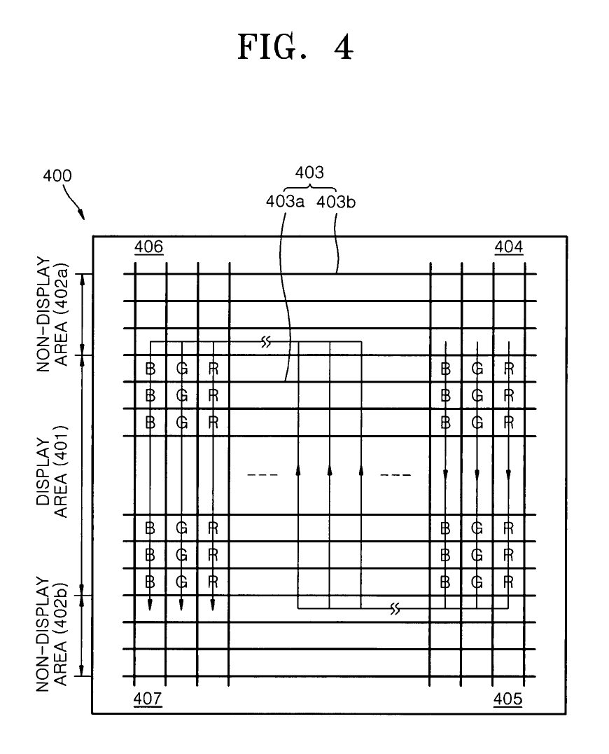

Hereinafter, processes of applying raw materials for phosphor layers according to embodiments of the present invention will be described with reference to FIGS. 4 through 8.

FIG. 4 is a diagram for describing a process of applying raw materials for phosphor layers according to an embodiment of the present invention. Referring to FIG. 4, a substrate 400 can be divided into a display area 401 and non-display areas 402a and 402b placed around the edges of the display area 401. The display area 401 is an area for displaying an image by emitting visible light as phosphor layers are excited by power applied to discharge electrodes. The non-display areas 402a and 402b are areas where the discharge electrodes are electrically connected to a signal transmitter, such as a flexible printed cable.

Barrier ribs 403 are formed on the display area 401 and the non-display areas 402a and 402b in a lattice type structure. The barrier ribs 403 include main barrier ribs 403a formed on the display area 403 and dummy barrier ribs 403b formed on the non-display areas 402a and 402b. The dummy barrier ribs 403b extend from the main barrier ribs 403a as integration.

The dummy barrier ribs 403b extend from the main barrier ribs 403a in order to prevent the main barrier ribs 403a from contracting and deforming when the barrier ribs 403 are calcinated. Also, the dummy barrier ribs 403b are formed in order to reduce noise generated when a plasma display panel is operating.

Red, green, and blue phosphor layers are respectively formed inside discharge cells defined by the main barrier ribs 403a. Also, the red, green, and blue phosphor layers are respectively formed in discharge cells defined by the dummy barrier ribs 403b.

The phosphor layers are formed in the discharge cells defined by the dummy barrier ribs 403b in order to preferentially discharge the raw materials for the phosphor layers on the non-display areas 402a and 402b so that the phosphor layers in the display area 401 have uniform thicknesses.

The process of applying the raw materials for the phosphor layers on the substrate 400 is described as follows.

First, the substrate 400, divided into the display area 401 and the non-display areas 402a and 402b around the edges of the display area 401, is prepared. Then, the main barrier ribs 403a are formed on the display area 401 and the dummy barrier ribs 403b, which extend from the main barrier ribs 403a, are formed on the non-display area 403b of the substrate 400. At the same time, discharge electrodes (not shown) are formed in the discharge cells defined by the barrier ribs 403. The discharge electrodes extend from the display area 401 to the non-display areas 402a and 402b.

Next, raw materials for the phosphor layers for emitting lights of various colors are applied in the discharge cells. The raw materials for the phosphor layers are continuously and simultaneously applied using a dispenser that moves from one discharge cell to another discharge cell and also moves from one direction to another direction on the substrate 400 after finishing application of the raw material to a column of the discharge cells. As defined above, an applying path is defined as a path along which the dispenser moves while applying the raw material for the phosphor layer to the substrate, and a moving path is defined as a path along which the dispenser moves regardless of the application of the raw material. Therefore, in this case, the moving path and the applying path are the same (or identical). That is, the dispenser moves from the top right side 404 to the bottom left side 407 along a determined paths while applying the raw materials for forming the red, green, and blue phosphor layers in discharge cells defined by the barrier ribs 403.

At this time, the starting position for discharging the raw materials is the non-display area 402a, which includes the top right side 404 of the substrate 400. After reaching the bottom right side 405 of the substrate, which is the non-display area 402b, the dispenser moves horizontally in order to apply the raw materials in other columns of adjacent discharge cells. Accordingly, the dispenser moves from bottom to top above the substrate 400 while applying the raw materials for the phosphor layers. The area where the dispenser moves horizontally corresponds to the non-display area 405. Meanwhile, the raw materials for the phosphor layers are applied on the top surface of the barrier ribs 403.

Through the above processes, the dispenser moves from the top right side 404 to the bottom right side 405, to the center region of the substrate 400, to the top left side 406, and to the bottom left side 407 of the substrate 400, and thus it can continuously simultaneously apply the raw materials for the red, green, and blue phosphor layers in the discharge cells.

According to the current embodiment, the moving path of the dispenser and the applying path of the raw materials are the same, and thus the raw materials can be applied by moving the dispenser along the path without stopping application of the raw material. Also, the starting point and the ending point of the operation of applying the raw materials are both in the non-display areas, and the beginning and stopping of the dispensing process for the red, green, and blue phosphor ends on the same line.

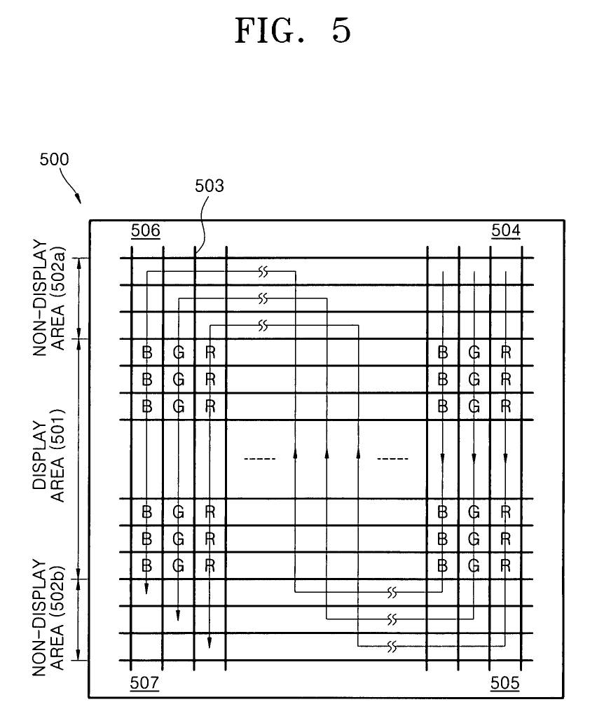

FIG. 5 is a diagram for describing a process of applying raw materials for phosphor layers according to another embodiment of the present invention. Referring to FIG. 5, a substrate 500 is prepared, and barrier ribs 503 are formed on the substrate 500. Then, raw materials for red, green, and blue phosphor layers are applied in discharge cells starting from a non-display area 502a corresponding to top right side 504 of the substrate 500 using a plurality of dispensers. The plurality of dispensers is located on the same line.

In the present embodiment, the moving speeds of dispensers respectively discharging the raw materials for the red, green, and blue phosphor layers are different. That is, the moving speed of the dispenser discharging the raw material for the red phosphor layer is the highest, the moving speed of the dispenser discharging the raw material for the green phosphor layer is intermediate, and the moving speed of the dispenser discharging the raw material for the blue phosphor layer is the lowest.

Due to the differences in the moving speeds, the dispensers reach different locations in the non-display area 502b corresponding to the bottom right side 505 of the substrate 500. That is, due to the differences in the moving speeds, the locations of the discharge cells, where the raw materials for the red, green, and blue phosphor layers are applied in the non-display area 502b, differ by one cell. Accordingly, when the raw materials for the red, green, and blue phosphor layers are applied from the top right side 504 to the bottom right side 505 of the substrate 500, the dispenser discharging the raw material for the red phosphor layer and having the fastest speed moves the farthest, and the dispenser discharging the raw material for the blue phosphor layer and having the slowest speed moves the least.

After reaching the bottom right side 505 of the substrate 500, the dispensers move horizontally in the non-display area 502b. Thus, since the moving speeds of the dispensers are different while moving from the top right side 504 to the bottom right side 505, each dispenser moves to a different location in the non-display area 502b.

Through the above processes, the dispenser moves from the top right side 504 to the bottom right side 505, to the center region, to the top left side 506, and to the bottom left side 507 of the substrate 500, and thus the raw materials for red, green, and blue phosphor layer are continuously simultaneously applied in the discharge cells.

As described above, in the current embodiment of the present invention, the starting points of the operation of applying the raw materials are the same (i.e., the top right side 504), but since the moving speeds of the dispensers are different, the locations of the dispensers in the non-display areas 502a and 502b are different. Accordingly, the phosphor layers do not overlap.

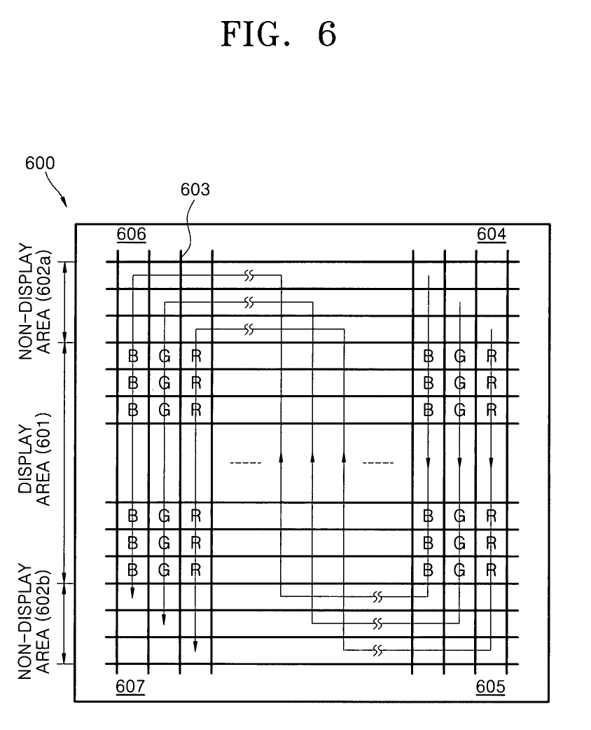

FIG. 6 is a diagram for describing a process of applying raw materials for forming phosphor layers according to another embodiment of the present invention. Referring to FIG. 6, after a substrate 600 is prepared, barrier ribs 603 in a lattice type structure are formed on the substrate 600. Then, dispensers discharging raw materials for red, green, and blue phosphor layers move from the top right side 604 to the bottom right side 605 of the substrate 600 while applying the raw materials for the red, green, and blue phosphor layers. In the present embodiments, the dispensers start at different locations in the non-display area 602a corresponding to the top right side 604.

Accordingly, when the dispensers move with the same speed, the dispenser discharging the raw material for the red phosphor layer in the non-display area 602b, which corresponds to the bottom right side 605 of the substrate 600, is located at the farthest distance from a display area 601, the raw material for the green phosphor layer is located at an intermediate distance from the display area 601, and the raw material for the blue phosphor layer is located at the nearest distance from the display area 601.

Next, the dispensers move horizontally to the center region of the substrate 600, and continuously move to the top left side 606 and the bottom left side 607 of the substrate 600 while applying the raw materials for respectively the red, green, and blue phosphor layers in the discharge cells. The dispensers for discharging red, green, and blue phosphors moves at the same speed while moving horizontally in the non-display area (near area 605).

As described above, the moving speeds of the dispensers discharging the raw materials for the red, green, and blue phosphor layers are the same, but the starting points of applying the raw materials are different. Accordingly, the dispensers are located at different positions in the non-display areas 602a and 602b, and thus the raw materials do not overlap.

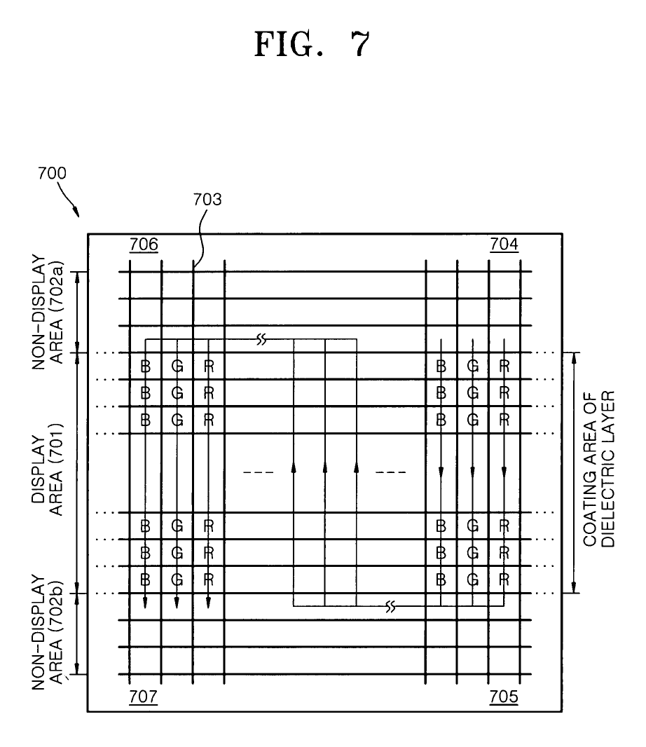

FIG. 7 is a diagram for describing a process of applying raw materials for phosphor layers according to another embodiment of the present invention. Referring to FIG. 7, barrier ribs 703 defining discharge cells are formed on a substrate 700. Then, dispensers discharging raw materials for red, green, and blue phosphor layers apply the raw materials starting from the same location in the top right side 704, and move to the bottom right side 705 of the substrate 700. Next, the dispensers move horizontally in a non-display area 708b and continuously move to the center, to the top left side 706, and to the bottom left side 707 of the substrate 700, while applying the raw materials for the red, green, and blue phosphor layers.

In the present embodiment, unlike in the above embodiments in which the discharge electrodes are patterned on the substrate and the dielectric layers are formed both on the display area and the non-display area, the dielectric layers are selectively formed only on a display area 701. Accordingly, thicknesses of the display area 701 and non-display areas 702a and 702b are different by the thickness of the dielectric layers. Thus, the raw materials for forming the phosphor layers are applied to the non-display areas 702a and 702b in the areas where the dielectric layers are not formed. Consequently, when the dispensers move horizontally, the height of the raw materials for forming the phosphor layers is as much as the height of the dielectric layers.

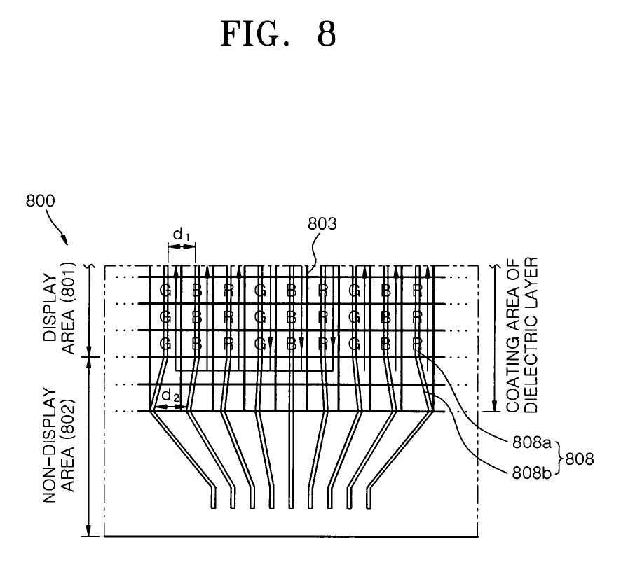

FIG. 8 is a diagram for describing a process of applying raw materials for phosphor layers according to another embodiment of the present invention. Referring to FIG. 8, barrier ribs 803 are formed on a substrate 800 and discharge electrodes 808 are patterned in discharge cells defined by the barrier ribs 803. Then, dispensers discharging raw materials for red, green, and blue phosphor layers move from top to bottom across the substrate 800, move horizontally in a non-display area 802, and continuously move from bottom to top across the substrate 800. This process is repeated in order to apply the raw materials for red, green, and blue phosphor layers in all of the discharge cells.

Here, an interval d1 between portions 808a of the discharge electrodes 808 disposed on the display area 801 and an interval d2 between portions 808b of the discharge electrodes 808 disposed on the non-display area 802 are different. That is, the interval d1 is relatively smaller than the interval d2. Accordingly, when the dielectric layers are formed on the display area 801 and the non-display area 802, thicknesses of the dielectric layers can be reduced since the interval d2 between the portions 808b on the non-display area 802 is relatively larger.

Accordingly, when the dispensers apply the raw materials for forming the red, green, and blue phosphor layers, the thicknesses of the raw materials for the red, green, and blue phosphor layers are reduced as much as the thicknesses of the dielectric layers.

The method of manufacturing the plasma display panel according to the present invention has the following advantages. First, the raw materials for forming the phosphor layers for emitting light of various colors can be simultaneously and continuously applied using the dispensers. Accordingly, the processes of applying the raw materials can be simplified. Second, the dispensers are located at different positions in the non-display area, and thus the overlapping height of the raw materials can be reduced. Third, a mis-discharge is prevented since the overlapping amount of the raw materials for forming the phosphor layers is reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a plasma display panel, the method comprising:
preparing a substrate having a display area for displaying an image and a non-display area surrounding the display area;
forming a plurality of discharge electrodes extending from the display area to the non-display area;
forming a plurality of barrier ribs defining discharge cells; and
continuously and simultaneously applying a plurality of raw materials for phosphor layers to the discharge cells from one discharge cell to another discharge cell on the substrate while moving a plurality of dispensers that contains the raw materials, the phosphor layers emitting lights of various colors in the discharge cells.

2. The method of claim 1, wherein the barrier ribs are formed in a predetermined pattern, the barrier ribs including main barrier ribs, which are formed on the display area, and dummy barrier ribs, which extend from the main barrier ribs and are formed on the non-display area.

3. The method of claim 1, wherein the step of applying of the raw materials for the phosphor layers including a step of simultaneously applying the raw materials to the discharge cells along one direction.

4. The method of claim 3, wherein the moving path of the dispensers and the applying path of the raw materials for the phosphor layers are the same.

5. The method of claim 3, wherein the discharge cells where the raw materials for forming the phosphor layer are applied are adjacent to one another.

6. The method of claim 1, wherein the simultaneously applying of the raw materials for phosphors layer comprising:
moving the dispensers from the display area to the non-display area along a first direction while applying the raw materials for phosphor layers;
moving the dispenser along a second direction in the non-display area; and
moving the dispensers from the non-display area to the display area while applying the raw material for phosphor layer.

7. The method of claim 6, wherein the first direction is substantially perpendicular to the second direction.

8. The method of claim 6, wherein the starting position and the ending position of applying the raw materials for the phosphor layers are located in the non-display area.

9. The method of claim 6, wherein the dispensers discharging the raw materials for the phosphor layers are located at the same position along the first direction, and move along the first direction at the same speed.

10. The method of claim 6, wherein the dispensers are located at the same position along the first direction in the non-display area, and move along the first direction into the display area at different speeds while applying the raw materials for the phosphor layers to the discharge cells.

11. The method of claim 10, wherein after the step of moving the dispensers from the display area to the non-display area along a first direction, the dispensers are located at different positions along the first direction in the non-display area.

12. The method of claim 6, wherein the dispensers are located at different positions along the first direction in the non-display area, and move along the first direction into the display area while applying the raw materials for the phosphor layers to the discharge cells.

13. The method of claim 12, wherein the dispensers move at the same speed along the first direction into the display area, and after the step of moving the dispensers from the display area to the non-display area along a first direction, the dispensers are located at different locations along the first direction in the non-display area.

14. The method of claim 13, wherein the dispensers move along the second direction in the non-display area while maintaining the different locations along the first direction in the non-display area.

15. The method of claim 1, further comprising:
forming a dielectric layer on the display area, the dielectric layer covering the discharge electrodes disposed on the display area, the dielectric layer not being formed on the non-display area.

16. The method of claim 15, wherein the simultaneously applying of the raw materials for phosphors layer comprising:
moving the dispensers from the display area to the non-display area along a first direction while applying the raw materials for phosphor layers;
moving the dispenser along a second direction in the non-display area; and
moving the dispensers from the non-display area to the display area while applying the raw material for phosphor layer.

17. The method of claim 1, wherein an interval between two of the discharge electrodes disposed in the non-display area, on which the raw materials for the phosphor layers are formed, is larger than an interval between two of the discharge electrode disposed on the display area.

18. The method of claim 1, wherein the raw materials for the phosphor layers are applied on the top of the barrier ribs.
